(19) United States
(12) Patent Application Publication
(10) Pub. No.: US 2015/0168189 A1
(43) Pub. Date: Jun. 18, 2015

(54) METHOD FOR DETERMINATION OF THE TIME OF FLIGHT OF THE SIGNALS IN THE SIGNAL PATHS OF A CORIOLIS FLOW METER

(71) Applicant: ABB Technology AG, Zurich (CH)

(72) Inventor: Frank WIEDERHOLD, Hofgeismar (DE)

(21) Appl. No.: 14/570,235

(22) Filed: Dec. 15, 2014

(30) Foreign Application Priority Data
Dec. 13, 2013 (DE) 102013021136.0

(51) Int. Cl. G01F 1/66; G01F 1/58; G01F 25/00

(52) U.S. Cl. CPC G01F 1/66; G01F 25/0007; G01F 1/586

(57) ABSTRACT

A method and system are disclosed for determination of a time of flight of working signals in a measuring instrument, which are respectively transmitted independently of one another via structurally equivalent individual signal paths from a respective signal source to a common signal sink, and for correction of the working signals. The method can include generating a test signal, which is superimposed simultaneously and in-phase on at least two working signals at identical structural elements of the structurally equivalent individual signal paths; determining time of flight differences of the test signal over the respective signal paths at the common signal sink; and correcting the phase differences of the working signals over the respective signal paths of the test signal as a function of the time of flight differences determined for the test signal.

### RELATED APPLICATION(S)

This application claims priority under 35 U.S.C. §119 to German Patent Application No. 102013021136.0 filed in Germany on Dec. 13, 2013, the entire content of which is hereby incorporated by reference in its entirety.

### FIELD

The disclosure relates to a method for determination of the time of flight of the signals in the signal paths of a Coriolis flow meter.

### BACKGROUND INFORMATION

Flow measuring devices of the Coriolis type are known, and can be described, for example, in DE 103 56 383 A1. Coriolis mass flow meters are based on the physical principle where an excitation unit sets the measurement tube in oscillation. The oscillations recorded at the inlet and outlet pickup points have the same phase in the neutral state. When there is a flow through the Coriolis mass flow meter in the operating state, the fluid mass can experience accelerated oscillation excursions, which can generate a Coriolis force. The originally uniformly shaped sinusoidal oscillation of the tube can experience influences due to the Coriolis force distributed along the measurement tube, which can cause a phase shift at the inlet and outlet pickup points. The oscillation phases and oscillation amplitudes at the inlet and outlet pickup points can be recorded by means of inlet and outlet sensors, and can be delivered to an evaluation unit. The size of the phase shift is a measure of the mass flow. By calibration, the way in which the phase shift is related to the mass flow can be established for each Coriolis mass flow meter.

In such flow measuring devices, phase differences between two or more sinusoidal measurement signals are measured. The signals may be the sensor signals and the driver current. The signals can then be fed along signal paths, which fulfill different tasks, such as amplification, level adjustment, and analog/digital conversion. Signal processing can evaluate the digital signals and can calculate the phase differences between the measurement signals.

The challenge in terms of measurement technology can be the small phase differences. In their signal paths, the signals have times of flight, which may be different in the individual paths, for example, owing to component tolerances.

It is known to correct an existing time of flight difference by balancing. The time of flight difference due to the drift as a function of temperature or aging cannot be compensated for by this balancing. For example, the different drift of the times of flight can lead to a measurement error, which furthermore changes during the operating time of the measuring instrument.

### SUMMARY

A method is disclosed for determination of a time of flight of working signals in a measuring instrument, which are respectively transmitted independently of one another via structurally equivalent individual signal paths from a respective signal source to a common signal sink, and for correction of the working signals, the method comprising: generating a test signal, which is superimposed simultaneously and in-phase on at least two working signals at identical structural elements of the structurally equivalent individual signal paths; determining time of flight differences of the test signal over respective signal paths at the common signal sink; and correcting phase differences of the working signals over the respective signal paths of the test signal as a function of the time of flight differences determined for the test signal.

A system is disclosed for determination of a time of flight of working signals in a measuring instrument, the system comprising: a plurality of signal sources, the plurality of signal sources being configured to generate working signals which are respectively transmitted independently of one another via structurally equivalent individual signal paths from a respective signal source; a test signal source, the test signal source being configured to generate a test signal which is superimposed simultaneously and in-phase on at least two working signals at identical structural elements of the structurally equivalent individual signal paths; and a common signal sink, the common signal sink being configured to: determine time of flight differences of the test signal over respective signal paths at the common signal sink; and correct phase differences of the working signals over the respective signal paths of the test signal as a function of time of flight differences determined for the test signal.

### BRIEF DESCRIPTION OF THE DRAWINGS

The disclosure is explained below with reference to the exemplary embodiments shown in the drawings. In the drawings:

FIG. 1 shows a diagram of an exemplary circuit arrangement for the determination of time of flight differences in signal paths in accordance with an exemplary embodiment;

FIG. 2 shows a diagram for graphical representation of exemplary signal times of flight for the determination of time of flight differences;

FIG. 3 shows a diagram for graphical representation of exemplary signal times of flight for the determination of time of flight differences;

FIG. 4 shows a diagram for the graphical representation of exemplary group delays;

FIG. 5 shows an exemplary circuit arrangement for the determination of time of flight differences in signal paths in accordance with an exemplary embodiment; and

FIG. 6 shows a representation of an exemplary circuit arrangement for the determination of time of flight differences in signal paths in accordance with an exemplary embodiment.

### DETAILED DESCRIPTION

In accordance with an exemplary embodiment, a mass flow meter is disclosed, of the Coriolis type, wherein measurement errors caused by signal time of flight differences can help be avoided irrespective of their origin.

In accordance with an exemplary embodiment, the disclosure is based on the mass flow meter, known per se, of the Coriolis type, in which phase differences between two or more sinusoidal working signals, which are respectively transmitted independently of one another via structurally equivalent signal paths from a respective signal source to a common signal sink, can be measured.

In accordance with an exemplary embodiment, a test signal can be generated, which can be superimposed simultaneously and in-phase on at least two working signals at identical structural elements of the structurally equivalent individual signal paths. The time of flight differences of the test signal over the respective signal paths can be determined at the common signal sink, and the phase differences of the working signals over the same signal paths of the test signal can be corrected as a function of the time of flight differences determined for the test signal.

In accordance with an exemplary embodiment, the same test signal can travel through different but structurally equivalent signal paths at the same time. If the signal times of flight through the different signal paths differ, then the same test signal can reach the common signal sink via the different signal paths at different times. The time of flight differences of the test signal can be calculated with the working signals that differ in phase.

As a result, measurement errors of the phase difference and therefore of the flow measurement signal of the flow measuring instrument due to time of flight differences between the individual signal paths can be avoided.

In accordance with an exemplary embodiment, the method according to the disclosure can be used at any time and under all operating conditions of the measuring instrument. For example, continuous compensation for time of flight differences of the working signals can be achieved even over the temperature variation or drift.

Furthermore, continuous checking of the zero point match of the phase difference at regular intervals can be avoided, because the time of flight errors can be continuously determined and corrected.

In accordance with an exemplary embodiment, a periodic test signal, the frequency of which lies in the frequency range of the working signal, can be superimposed on the working signal.

In accordance with an exemplary embodiment, a periodic test signal including two test frequencies, which are the upper and lower cutoff frequencies of the frequency range of the working signal, can be superimposed on the working signal.

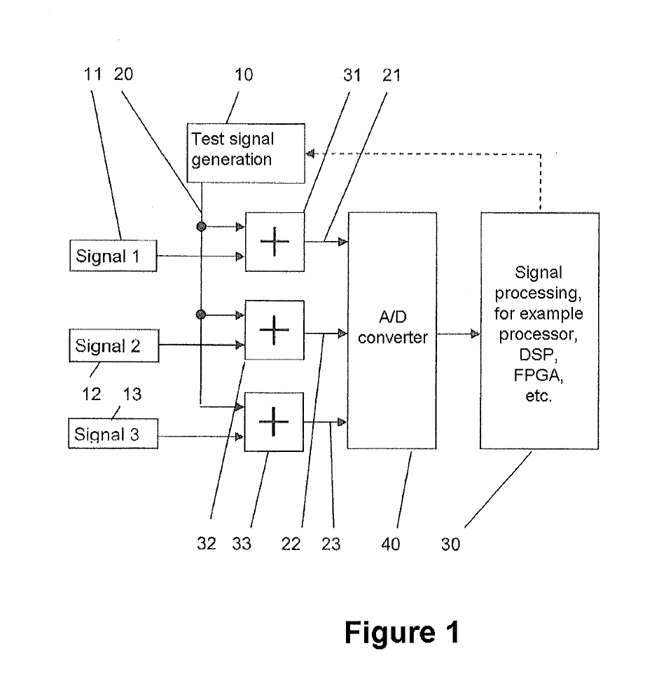

FIG. 1 shows an outline structural circuit diagram for the determination of time of flight differences in different signal paths 21, 22, 23 between individual signal sources 11, 12, 13 and a common signal sink 30, as well as for compensation thereof. A signal combiner 31, 32, 33, which has two inputs, can be respectively connected to each signal path 21, 22, 23 at its signal source 11, 12, 13. One input can be respectively connected to the associated signal source 11, 12, 13 and the other input can be connected to a common test signal source 10.

The test signal source 10 can deliver a test signal 20, which can be combined by means of the signal combiners 31, 32, 33 with the working signals 1, 2, 3 of the signal source 11, 12, 13.

In accordance with an exemplary embodiment, the signal sink 30 can be preceded by an A/D converter 40, at which the signal paths 21, 22, 23 end. The working signals 1, 2, 3 as well as the test signal 10 can be computationally processed in the signal sink 30. In accordance with an exemplary embodiment, the signal sink 30 can have at least one processor, DSP (digital signal processor) or FPGA (field-programmable gate array), for example.

In an exemplary embodiment of the disclosure, the signal sink 30 can be connected to the test signal source 10. For example, the test signal source 10 can be formed as a D/A converter that delivers digital test patterns, which can be generated in the processor of the signal sink 30, as analog test signals 20.

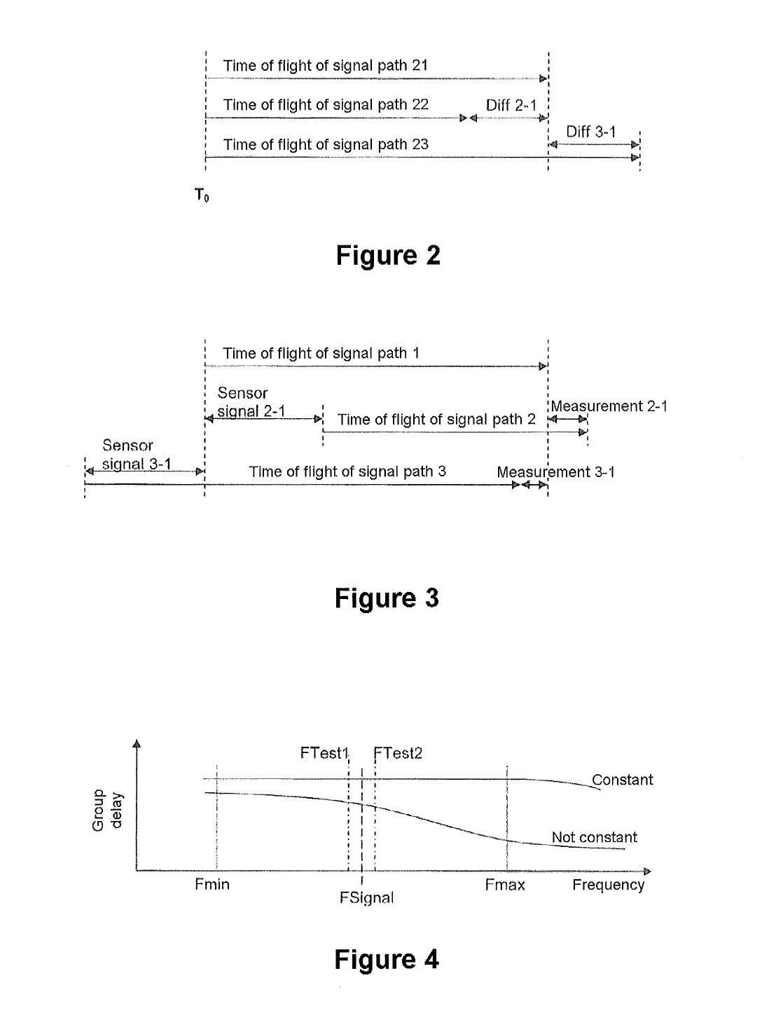

FIG. 2 shows a diagram for the graphical representation of exemplary signal times of flight. Starting from a starting time T₀, the signal times of flight of the working signals 1, 2 and 3 on the signal paths 21, 22 and 23 are plotted. If the times of flight in the individual signal paths 21, 22 and 23 were equal, the test signal 20 in the individual signal paths 21, 22 and 23 could also arrive simultaneously at the signal sink 30. When there is time of flight differences, however, the test signal 20 arrives at the signal sink 30 with corresponding time differences Diff 2-1 and Diff 3-1. The time differences Diff 2-1 and Diff 3-1 are the differences in the signal times of flight of signal path 22 relative to signal path 21, and signal path 23 relative to signal path 21, respectively. In accordance with an exemplary embodiment, an exemplary feature of this disclosure is that the same test signal 20 can be added to all the signal paths 21, 22 and 23. In this way, for example, the starting time T₀ of the test signal 20 can be the same for all signal paths 21, 22 and 23. The signal evaluation in the signal sink 30 records the time differences Diff 2-1 and Diff 3-1 with which the test signal 20 enters the signal sink 30.

FIG. 3 shows an example of the phase measurement of the measurement signals. For example, between the working signal 2 on the signal path 22 and the working signal 1 on the signal path 21, there is a time difference Sensor signal 2-1, for example, due to the Coriolis force. This time difference can be measured in the signal processing as a time difference Measurement 2-1. Due to time of flight differences in the signal paths 21 and 22, there is a difference between Measurement 2-1 and Sensor signal 2-1, which without corrective measures could entail a measurement error. The measurement value Measurement 2-1 can be corrected with the time of flight difference Diff 2-1 determined by means of the test signal 20, in order to obtain a correct measurement value. The same can be carried out for the further signal paths 23.

The test signal 20 can be controlled by the signal processing in the signal sink 30, which can switch the test signal 20 on and off, and adjust the frequency, amplitude and signal waveform. In accordance with an exemplary embodiment, the test signal 20 can be a sine signal. Other signal waveforms can, however, also be used, for example the superposition of two sine signals with different frequencies, or other periodic signals, for example, individual non-periodic signals. In accordance with an exemplary embodiment, a specification of the test signal 20 is that the signal evaluation in the signal sink 30 can measure its time of flight difference as well as possible. For example, one method of generating the test signal 20 can be a digital/analog converter driven by the signal processing in the signal sink 30, which converter can representing the test signal source 10.

The frequencies of the measurement signals of a Coriolis mass flow measuring device can depend on certain parameters, for example, above all the rated width and the medium. In accordance with an exemplary embodiment, the minimum and maximum frequencies will be referred to below as Fmin and Fmax. Values can be, for example, from 80 Hz to 800 Hz.

Simulation programs for electronic circuits, with which the time of flight of signals in analog circuits can be simulated, are known. The simulation programs indicate the so-called group delay for a frequency range. For example, the signal input can be simulated and the specific circuit can be designed.

For the group delay of the signal input, two cases can be distinguished, which can be represented in FIG. 4. If the group delay is sufficiently constant over the frequency range Fmin to Fmax, then the frequency of the test signal 20 may be selected arbitrarily in the range, or just outside it. If the group delay is not sufficiently constant, however, the test frequency of the test signal 20 should lie close to the signal frequency FSignal. Provision may also be made to switch on two test frequencies FTest1 and FTest2, which lie above and below the signal frequency FSignal, alternately or in superposition, and to interpolate their time of flight differences.

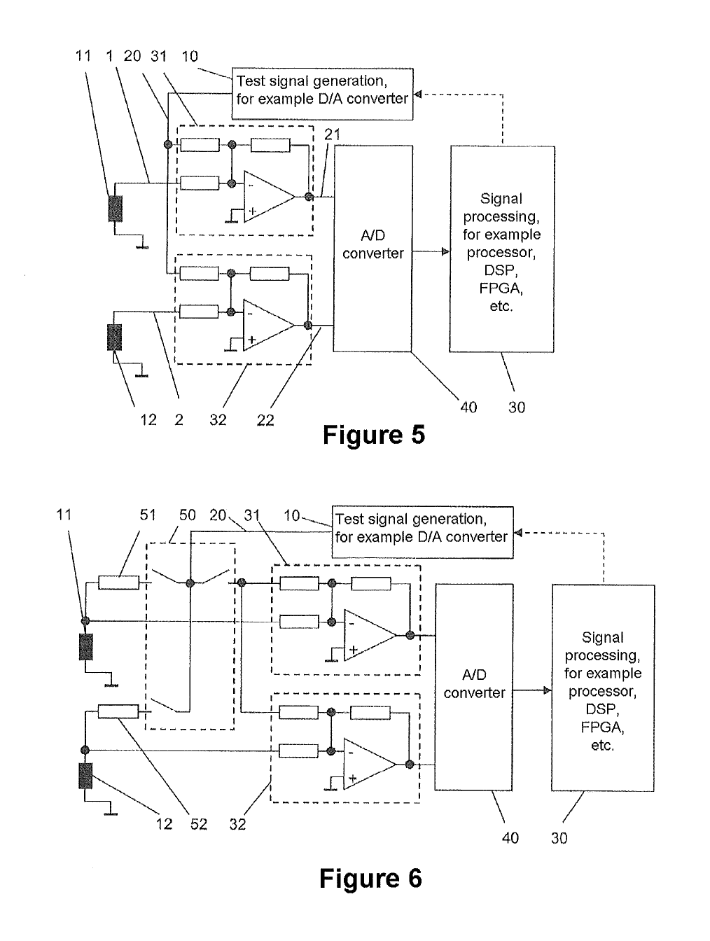

An exemplary circuit arrangement for the determination of time of flight differences in signal paths 21, 22, in principle with reference to the example of a sensor instrument having a flow measuring instrument, is represented in FIG. 5 while using the same references for the same means. In accordance with an exemplary embodiment, the signal sources 11, 12 can be formed as sensor coils. The signal combiners 31, 32 can be formed as operational amplifier circuits, which can be connected as adders. Each adder can add the test signal 20 without feedback to the respective measurement signal 1, 2 of the signal sources 11, 12. In accordance with an exemplary embodiment, the test signal 20 has no perturbing effect on the measurement signal sources 11, 12 or the measurement signals 1, 2.

In accordance with an exemplary embodiment, only two signal paths 21, 22 are represented in FIG. 5. However, additional signal paths for further signals, for example, the driver current of the flow measuring instrument can also be shown. In accordance with an exemplary embodiment, the advantage of this circuit is that the test signal 20 is provided at the same addition point, which in this case is formed by the negative input of the operational amplifier, as the measurement signal 1, 2. For example, the entire signal path 21, 22 can be respectively controlled by the test signal 20.

In an exemplary embodiment, the test signal 20 may be switched alternately to the signal combiners 31, 32 or directly to the signal sources 11, 12.

An expanded circuit arrangement for the determination of time of flight differences in signal paths 21, 22, in principle with reference to the example of a sensor instrument of a flow measuring instrument, is represented in FIG. 6 while using the same references for the same means. For example, in accordance with an exemplary embodiment, a switching device 50 can be used, which can have a multiplicity (or plurality) of switches and can allow alternate switching of the test signal 20 to the signal combiners 31, 32, or respectively via an impedance 51, 52 to the sensor coils 11, 12.

When the test signal 20 is switched to the signal combiners 31, 32, the functionality can be the same as the circuit arrangement according to FIG. 5.

When the test signal 20 is switched to the sensor coil 11, 12, the known impedance 51, 52 with the associated sensor coil 11, 12 to be measured respectively forms a voltage divider. The voltage of the test signal 20 at the voltage divider can be measured by means of the A/D converter 40. Determination of the time of flight differences of the signal paths 21, 22, this embodiment of the disclosure furthermore allows diagnosis of the sensor coils 11, 12.

In accordance with an exemplary embodiment, the test signal 20 can be generated by means of a D/A converter 10 of the signal processing in the signal sink 30. The phase between the generated test signal 20 and the voltage at the voltage divider can be then furthermore known.

For example, with a test frequency, for example, of a few kHz for the test signal 20, the phase angle can be determined to two-digit degree accuracy. From the two items of information, it is possible to calculate the resistance R and the inductance L of the sensor coil 11, 12 can be calculated. For example, the coil diagnosis can be only provided on demand, or at particular time intervals.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCES

1, 3 Working signal

10 Test signal source

11, 13 Signal source

20 Test signal

21, 23 Signal path

30 Signal sink

31, 33 Signal combiner

40 ND converter

50 Switching device

51, 52 Impedance

What is claimed is:

1. A method for determination of a time of flight of working signals in a measuring instrument, which are respectively transmitted independently of one another via structurally equivalent individual signal paths from a respective signal source to a common signal sink, and for correction of the working signals, the method comprising:
generating a test signal, which is superimposed simultaneously and in-phase on at least two working signals at identical structural elements of the structurally equivalent individual signal paths;
determining time of flight differences of the test signal over respective signal paths at the common signal sink; and
correcting phase differences of the working signals over the respective signal paths of the test signal as a function of the time of flight differences determined for the test signal.

2. The method as claimed in claim 1, comprising:
superimposing a periodic test signal on a working signal, wherein a frequency of the periodic test signal lies in a frequency range of the working signal.

3. The method as claimed in claim 1, comprising:
superimposing a periodic test signal consisting of two test frequencies on a working signal.

4. The method as claimed in claim 3, wherein one of the two test frequencies is an upper, and another of the two test frequencies is lower, cutoff frequency of a frequency range of the working signal.

5. The method as claimed in claim 3, wherein one of the two test frequencies is greater than, and another of the two test signals is less than, a measurement frequency of the working signal.

6. The method as claimed in claim 1, comprising:
introducing the test signal between a respective signal source and a respective signal path.

7. The method as claimed in claim 1, comprising:
introducing the test signal directly into the signal source.

8. The method as claimed in claim 7, comprising:
introducing the test signal via an impedance onto sensor coils of the measuring instrument.

9. A system for determination of a time of flight of working signals in a measuring instrument, the system comprising:
a plurality of signal sources, the plurality of signal sources being configured to generate working signals which are respectively transmitted independently of one another via structurally equivalent individual signal paths from a respective signal source;
a test signal source, the test signal source being configured to generate a test signal which is superimposed simultaneously and in-phase on at least two working signals at identical structural elements of the structurally equivalent individual signal paths; and
a common signal sink, the common signal sink being configured to:
determine time of flight differences of the test signal over respective signal paths at the common signal sink; and
correct phase differences of the working signals over the respective signal paths of the test signal as a function of time of flight differences determined for the test signal.

10. The system as claimed in claim 9, comprising:
a periodic test signal having a frequency which lies in a frequency range of a working signal, and which is superimposed on the working signal.

11. The system as claimed in claim 9, comprising:
a periodic test signal consisting of two test frequencies, which is superimposed on a working signal.

12. The system as claimed in claim 11, wherein one of the two test frequencies is an upper, and another of the two test signals is lower, cutoff frequency of a frequency range of a working signal.

13. The system as claimed in claim 11, wherein one of the two test frequencies is greater than, and another of the two test signals is less than, a measurement frequency of the working signal.

14. The system as claimed in claim 9, wherein the test signal is introduced between a respective signal source and a respective signal path.

15. The system as claimed in claim 9, wherein the test signal is directly introduced into a signal source.

16. The system as claimed in claim 15, in combination with a measuring instrument, wherein the test signal is introduced via an impedance onto sensor coils of the measuring instrument.

17. The system as claimed in claim 9, comprising:
an ND converter, wherein respective signal paths end.

18. The system as claimed in claim 9, wherein the common signal sink comprises:
at least one processor, DSP, or FPGA.

19. The system as claimed in claim 9, comprising:
a switching device having a plurality of switches and configured to alternate switching of the test signal to signal combiners, or via an impedance to sensor coils.

20. The system as claimed in claim 9, comprising:
a signal combiner having a first input connected to one of the respective signal sources and a second input connected to the test signal source.
